(19) United States
(12) Patent Application Publication
(10) Pub. No.: US 2002/0162461 A1
(43) Pub. Date: Nov. 7, 2002

(54) Micro-porous enclosure for delivering and stirring infusible and water-soluble potable matter into a liquid

(76) Inventor: David Soumekh, Los Angeles, CA (US)

Correspondence Address: Law Offices of Clark D. Gross, Suite 300, 12304 Santa Monica Boulevard, Los Angeles, CA, 90025-2593, US

(21) Appl. No.: 10/099,925

(22) Filed: Mar. 15, 2002

Related U.S. Application Data
(60) Provisional application No. 60/287,773, filed on May 1, 2001.

(51) Int. Cl. A01J 11/04

(52) U.S. Cl. 99/467

(57) ABSTRACT

A sealed enclosure (10, 32) affords the infusion and dissolution of the essences of infusible and water-soluble potable matter (15) into liquids. The enclosure is provided with micro-porous openings or interstices (26), e.g., spacings (28) between fibers or holes or perforations (30) in a film whose opening sizes and density per unit area substantially eliminates the effect of surface tension. For infusible matter, the micro-porous openings form a screen which is smaller than the nominal size of the contents to permit infusion, without passage of the matter per se, of their taste or essence into the liquid. A pleated enclosure (30) permits a limited expansion a more efficient diffusion of the taste or essence of the ingredients into the liquid without preventing the contents from brewing or soaking too long in the liquid and possibly to change the taste before, for example, a bitter taste is imparted to the liquid. The sealed inclosure is preferably formed from a relatively rigid material to enable it, per se, to act as a stirring rod or swizzle stick.

### CROSS-REFERENCE TO RELATED APPLICATION

This application claims the benefit of U.S. Provisional Application No. 60/287,773, filed May 1, 2001.

### REFERENCE REGARDING FEDERAL SPONSORSHIP

Not Applicable

### REFERENCE TO MICROFICHE APPENDIX

Not Applicable

### BACKGROUND OF THE INVENTION

1. Field of the Invention

The present invention relates to a sealed enclosure of infusible and water-soluble potable matter for respective infusion and dissolution of the matter into liquids and, in particular, to improvements in upgraded treatment of such matter. The sealed enclosure is preferably stiffened so as to be capable of acting also as a stirring rod.

2. Description of Related Art and Other Considerations

Vehicles for infusing and dissolving potable ingredients or other matter into liquids are well known. Tea in a tea bag, for example, is representative of infusion matter. Sugar and salt, for example, is representative of dissolvable matter; however, it is conventional practice to tear open a package containing such dissolvable matter and not to place it in a tea-bag type enclosure. Thus, it is conventional to permit liquid enter through openings in the enclosure to enable wetting of the matter and to extract its essence into the liquid.

For some matter, which is not potable, such as non-oral pharmaceuticals, or even not human-consumable, such as additives or non-foods, e.g., salts or minerals for aquariums and chemicals for water-conditioning and for hot tubs, it would be desirable or simply convenient for one to have the ability to contain and then deliver a wide variety of products or their essences into solution.

In addition, some products, which are in a crystalline, powder and granule form, are traditionally packaged in a liquid solution, which products include medications. It would be further desirable to package such products in a pre-measured and dry form for enabling them to the easily carried by the user. When required to be administered or taken, it would be convenient simply to reconstitute such a dry product in solution.

Concisely stated, a need is seen for inserting matter or the essences of matter, whether ingestable or not, into solution by means of infusion, dissolving, decocting, etc.

Technologies have been designed for providing openings of differing configurations by perforating the tubular membrane in-situ with holes (typically 0.5 millimeters) covering no more than five percent of the surface area through which the matter must pass. Making the openings smaller renders the product unusable, thereby restricting the nature of the matter. For example, too small a size of tea leaves would permit them to pass through the openings. When the leaf size is increased to mitigate this problem, the larger leaf can clog the openings, thus steeping more slowly and relinquishing less brew strength. The problem is further compounded by the fact that water will have cooled before the tea has fully brewed and, therefore, cannot be enjoyed at the user-desired temperature.

Most potable granular products, such as sugar and instant coffee, cannot be effectively packaged. These products tend to break down, due to abrasion in transit, allowing the matter to pass through the openings prior to when such passage is desired.

During the manufacturing process, a typical way to feed the matter into the tube is to use a gravity feeding process using a form, fit and seal machine, such as, e.g., using technology developed by the General Packaging Equipment Company, as for example, described in U.S. Pat. No. 4,090,344 entitled “Method and Apparatus for Automatically Filling Bags with Particulate Material” and U.S. Pat. No. 4,534,159 entitled “Apparatus for Forming, Filling and Sealing Bags with Fluid Contents.” Air flushing, which would speed up the manufacturing process considerably, cannot be employed, because the opening density is not adequate for the air to pass through.

The in-situ technique of making openings becomes a second bottleneck because the opening-punching device can only proceed at a certain rate, again retarding the speed of the manufacturing process.

### SUMMARY OF THE INVENTION

These and other problems are successfully addressed and overcome by the present invention. Matter is retained within an enclosure having openings which are sized and have densities per unit area to substantially eliminate the effect of surface tension of the liquid and, therefore, to permit the liquid to come into contact with the matter. This encourages respective infusion and dissolution of the essences into the liquid, whether the matter is embodied as an infusible or a water-soluble potable ingredient.

The openings are sized so as to become microscopic holes or micro-pores, that is, the size of the opening and the density of the openings per unit area substantially eliminate the effect of surface tension. When the contents comprises infusible matter, such as tea leaves, the micro-pores act collectively as a screen smaller than the nominal size of such matter. Thus, when the micro-pores of the matter are sized smaller than the contents within the sealed enclosure, the enclosure becomes a filter preventing escape of the contents but allowing the free flow of liquid into and through the micro-pores. Therefore, as an important condition for carrying forth the concepts of the present invention, an opening becomes a micro-pore when the surface tension of water, for example, be it hot or cold, keeps the contents of the membrane from flowing freely through the membrane. Thus, the effective employment of the micro-pore technology is to group the micro-pores closely together.

The micro-pores may be arranged in numerous configurations and patterns, allowing for a great deal of design flexibility. The micro-pores may be formed by a standard perforation technique, such as running a film through rollers.

The sealed enclosure is preferably stiffened so as to be capable of acting also as a stirring rod.

A pleated enclosure is useful to permit diffusion without needing the enclosure to steep for too long a period of time in the liquid that could cause a change in taste, such as a bitter taste. Thus, the expandible nature of the pleated tube is beneficial when it is desired to limit the amount of expansion of the contents. Therefore, it is possible to place a limit on the brewing process by stopping the flow of liquid through the contents.

Several advantages are derived from this arrangement. Micro-pore technology speeds up the steeping/dissolution rate considerably. The use of micro-pores on over a percent, e.g., thirty to fifty percent, of the surface area allows for the air flushing process to be employed. Having the membrane pre-perforated allows for the use of a standard form, fill and seal machine with fewer limits on production speed.

Other aims and advantages, as well as a more complete understanding of the present invention, will appear from the following explanation of exemplary embodiments and the accompanying drawings thereof.

### BRIEF DESCRIPTION OF THE DRAWINGS

FIG. 1 is a perspective view of a preferred embodiment of the present invention configured as a tube formed from porous membrane;

FIG. 2 is a longitudinal, cross-sectional view of the embodiment depicted in FIG. 1;

FIG. 3a is a horizontal, cross-sectional view of the embodiment depicted in FIG. 1 when the porous membrane is formed from fin-sealed or lap-sealed ribbon stock;

FIG. 3b is a horizontal, cross-sectional view of the embodiment depicted in FIG. 1 when the porous membrane is formed from tubular stock;

FIGS. 4 and 5 are detail views of portions of two micro-pore perforations of representative membranes useful in the construction of membranes employable in the present invention;

FIG. 6 is cross-sectional view of an alternate embodiment of the present invention, taken along a line similar to that with respect to FIG. 3, but showing an expandable or pleated configuration of the tube in its condition prior to expansion; and

FIG. 7 is a view of the embodiment depicted in FIG. 6 after expansion due to absorption of liquid into the matter.

### DETAILED DESCRIPTION OF THE PREFERRED EMBODIMENTS

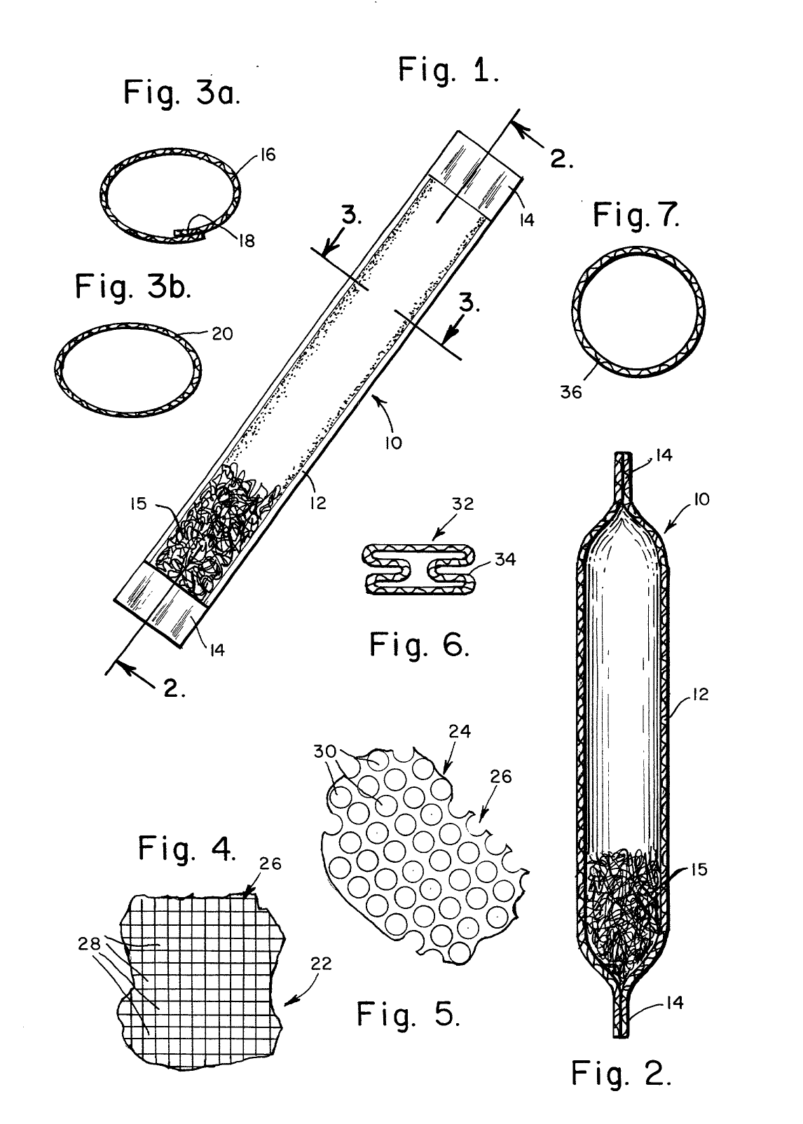

As depicted in FIGS. 1 and 2, a micro-porous enclosure 10 comprises a closed system for retaining infusible, dissolvable and decoctable matter, such as tea leaves, sugar, minerals, salts and pharmaceuticals. In its preferred realization, enclosure is formed as an elongated stiff tube 12 sealed at its ends 14. Matter 15, comprising an ingredient having an essence or other characteristic (e.g., a sweetener, pharmaceutical, water-softener), is contained within enclosure 10, which is disposed to be placed into a liquid so that the essence of the matter is infused or dissolved, depending upon the character of the contents, into the liquid. If desired, more than one ingredient may be contained within the enclosure, e.g., tea and a sweetener. When tube 12 is formed of a stiff material, it can be employed as a stirring device to aid in the flow of the liquid into contact with the contents.

Enclosure 10 can be formed in a multitude of methods, such as disclosed in above-mentioned U.S. Pat. Nos. 4,090,344 and 3,534,344 respectively entitled “Method and Apparatus for Automatically filling Bags with Particulate Materials” and “Apparatus for Forming, Filling and Sealing Bags with Fluid Contents.” It is to be understood that such apparatus and methods are presented as acceptable means for accomplishing the aims and advantages of the present invention and that other equivalent apparatus and methods may be utilized with like results.

The starting material used for enclosure 10 may comprise a long ribbon or like membrane having microscopic openings or micro-pores formed therein. Such microscopic openings or micro-pores are an important feature of the present invention, as more fully discussed below. Machines, such as the above-mentioned machines, configure the ribbon-line membrane into a tube, which may take the form of a fin-sealed tube 16 shaped from a flat membrane having a lap-seal 18, as shown in FIG. 3a, or begin with a cylindrically formed tube 20, as illustrated in FIG. 3b. Regardless, the machine fills the tube with the ingredients forming the infusible and dissolvable matter in a stepped fill, sealing and cutting process.

Regardless of whether configured as depicted in FIGS. 3a and 3b, enclosure 10 may be formed from a mesh 22 or a perforated film 24 of single or laminated material, such as is illustrated in FIGS. 4 and 5, having openings or interstices 26 such as spacings 28 between woven or unwoven fibers and between openings or perforations 30. Micro-pores configured as holes may be formed by standard perforation techniques, such as running a plastic film through rollers respectively equipped with alternating rows of mated spokes and apertures. Alternatively, the film can be stretched and then set by heat into a finalized form.

Regardless of the specific construction, the spacing of the interstices provided by the openings of the mesh or perforations form microscopic openings or micro-pores which are sized and have densities per unit area to substantially eliminate the effect of surface tension of the liquid and, therefore, to encourage respective infusion and dissolution of the essences of the infusible and water-soluble potable matter into the liquid. The openings are generally less than 0.5-0.35 millimeters wide; however, the specific opening size will vary depending upon the particular matter held within the enclosure. In a preferred embodiment, the combined area of micro-pores cover at least fifty percent of the surface of that part of the tube through which the ingredients must pass. Should the micro-pores not be spaced sufficiently close together, unacceptable surface tension is found to develop and, therefore, flow through the micro-pores is retarded or restricted.

The micro-pores can be made in many different shapes, e.g., square, hexagonal, oval, triangular and oblong. Groupings or clusters of the micro-pores can also be in any shape, provided that, within each grouping, the density of the micro-pores as such as to avert the effects of surface tension. Experimental evidence indicated that a 30% to 50% density provides a sufficient aversion to surface tension; however, it is to be understood that such experimental evidence is not to be taken as a limitation to the density but, simply, as a preference of the surface area density of the perforated membrane. When the shape of the micro-pore is other than circular, the width of the pore should not normally exceed about 0.35 millimeter. The length of the pore may exceed 0.35 millimeter without compromising efficiency. Further, the micro-pores can be reduced in size indefinitely, provided that over fifty percent of the area through which the matter must pass, is always perforated, thus allowing for the use of an indefinite variety of matter in an infinite variety of forms and sizes.

The membrane may be constructed of synthetic fabric, such as food-grade polymer, e.g., polypropylene, which is capable of maintaining structural integrity beyond the temperature, for example, of boiling water. Such a food-grade polypropylene would be one hundred microns thick. Another membrane appropriate for use in the present invention comprises a tri-laminate sandwich formed from a middle layer of food-grade aluminum, e.g., 20 microns in thickness, and top and bottoms layers of 40 micron polypropylene.

The woven mesh may be constructed from a food-grade monofilament polymer, such as polypropylene netting or gauze, alternating with a stabilized yarn.

Regardless of the specific materials used, as stated above, it is very useful for the tube to have sufficient rigidity as to maintain its structural integrity during use, so that it may be used also as a stirring rod in which the stirring action also permits the essence in the contained matter, or the material per se, to be infused or dissolved, as the case may be, into the liquid medium. Such a rigid tube avoids the need to use a secondary stirring device, such as a spoon or swizzle stick.

Another embodiment of the present invention is depicted in FIGS. 6 and 7. Here, an enclosure 32 is packaged in a pleated or gusseted configuration 34, as illustrated in FIG. 6, prior to its being immersed in a liquid. After immersion, enclosure 32 expands into a deployed tubular shape, as designated by indicium 36 as shown in FIG. 7. The pleating enables diffusion of the essences without permitting the enclosure from staying too long in the fluid so as to limit or stop the brewing before a bitter taste is imparted to the liquid.

Although the invention has been described with respect to particular embodiments thereof, it should be realized that various changes and modifications may be made therein without departing from the spirit and scope of the invention.

What is claimed is:

1. A sealed device for supplying the essences of infusible and water-soluble potable matter into a liquid comprising an enclosure having openings which are sized and have densities per unit area substantially to eliminate the effect of surface tension of the liquid and, thus, to encourage respective conveyance of the essences into the liquid.

2. A sealed device according to claim 1 in which said enclosure comprises a tri-laminated material including a construction formed from layers of a polymer material sandwiched about an aluminum layer.

3. A sealed device according to claim 1 in which the openings comprise micro-pores that form a screen in which the micro-pores are smaller than the nominal size of the matter when the matter comprises infusible matter.

4. A sealed device according to claim 3 in which said enclosure comprises a woven membrane.

5. A sealed device according to claim 4 in which said woven membrane comprises food-grade monofilament polymer.

6. A sealed device according to claim 5 in which said monofilament polymer comprises a polypropylene netting or gauze alternating with a stabilized yarn.

7. A sealed device according to claim 3 in which said enclosure comprises a tri-laminated material including a construction formed from layers of a polymer material sandwiched about an aluminum layer.

8. A sealed device according to claim 3 in which said enclosure is embodied as a tube.

9. A sealed device according to claim 8 in which said tube is formed from a sheet of material lap-sealed upon itself.

10. A sealed device according to claim 8 in which said tube is formed from a sheet of material fin-sealed upon itself.

11. A sealed device according to claim 3 in which said enclosure is formed from an expandible container.

12. A sealed device according to claim 11 in which said container has a pleated configuration to permit its expansion as the contained matter expands upon contact with the liquid without causing a squeezing pressure upon the matter.

13. A sealed device according to claim 1 in which said enclosure has sufficient rigidity which provides a adequate structural integrity to permits its employment as a stirring rod for permitting the essence of the matter contained in the enclosure to be conveyed into the liquid.

14. A sealed device according to claim 1 in which the matter contained in the enclosure is in crystalline, powder and granular form, and in combinations thereof.

15. A sealed device according to claim 14 in which the matter comprises a pre-measured medication in dry form which is dissolvable in a ready-to-use form.

16. A method for supplying the essences of infusible and water-soluble potable matter into a liquid comprising the steps of providing openings in an enclosure which are sized and have densities per unit area to substantially eliminate the effect of surface tension of the liquid and, therefore, to encourage respective infusion and dissolution of the essences into the liquid.

17. A method according to claim 16 further comprising the step of forming the openings as micro-pores to form a screen that are smaller than the nominal size of the matter when the matter comprises infusible matter.

18. A sealed device for supplying the essences of infusible and water-soluble matter into a liquid comprising an enclosure having openings which are sized and have densities per unit area substantially to eliminate the effect of surface tension of the liquid and, thus, to encourage respective conveyance of the essences into the liquid.

19. A method for supplying the essences of infusible and water-soluble matter into a liquid comprising the steps of providing openings in an enclosure which are sized and have densities per unit area to substantially eliminate the effect of surface tension of the liquid and, therefore, to encourage respective infusion and dissolution of the essences into the liquid.

20. A method according to claim 14 further comprising the step of forming the openings as micro-pores to form a screen that are smaller than the nominal size of the matter when the matter comprises infusible matter.
